(19) United States
(12) Patent Application Publication
(10) Pub. No.: US 2019/0001375 A1
(43) Pub. Date: Jan. 3, 2019

(54) Blade Cleaner and Method of Using

(71) Applicant: Elyano Nascimento, Bridgeport, CT (US)

(72) Inventor: Elyano Nascimento, Bridgeport, CT (US)

(21) Appl. No.: 16/023,757

(22) Filed: Jun. 29, 2018

Related U.S. Application Data
(60) Provisional application No. 62/527,688, filed on Jun. 30, 2017.

(51) Int. Cl. B08B 1/04; B08B 1/00; B08B 3/08

(52) U.S. Cl. CPC B08B 1/04; B08B 3/08; B08B 1/002

(57) ABSTRACT

A blade cleaner system having a housing, at least one basin set within the housing, and the housing having at least one opening sized to receive a shaving blade. At least one rotatably operated cleaning agent, having multiple bristles, adapted to clean the shaving blade, being located proximate to the at least one opening and a cleaning solution being present within the at least one basin, wherein during operation, the cleaning solution is in contact with a first portion of the at least one cleaning agent and a second portion of the cleaning agent does not contact the cleaning solution.

### CROSS-REFERENCE TO RELATED APPLICATIONS

This patent application claims the benefit, under 35 U.S.C. § 119(e), of U.S. Provisional Patent Application Ser. No. 62/527,688, filed on Jun. 30, 2017, the content of which is incorporated herein by reference in its entirety.

### FIELD OF THE INVENTION

The present teachings relate generally to a system and method of quickly and efficiently cleaning razors, safety razors, and razor blade cartridges to improve performance and longevity.

### BACKGROUND OF THE INVENTION

Over the years a number of developments have taken place in the shaving marketplace. Shaving blades went from straight razors to double-edged safety razors to now employing disposable shaving cartridges with multiple blades. Typically, a blade cartridge can include any number of blades, with the standard today being between two and five blades.

A user typically will apply shaving cream to a desired area prior to shaving with a razor. With each pass and stroke a safety razor or cartridge will accumulate a buildup of hair and shaving cream between the blades, instantly reducing their performance. If the buildup is not removed immediately after use, the mix of hair and product has a tendency to cake the blades and dramatically reduce performance for the next use.

After as little as one stride of shaving, a blade cartridge may get full of shaved hair and shaving cream, causing buildup which can block a substantial amount of the blade. Instead of using 100% of the blades, users end up using between 30-80% of the blades. This can cause the user to have to shave over the same area multiple times, potentially causing razor bumps and cuts.

Many consumers are frustrated by the reduced performance of their blades due to clogging from hair and dried-up shaving cream. Consumers tend to replace blade cartridges because of the dirty and rusty appearance due to buildup of clogged hair and dried-up shaving cream, and believe that the buildup causes dullness in used razor blades. As a result, many users are left dissatisfied with the inferior performance of the used, dull blades.

Simply using a faucet to rinse off the residue has its own drawbacks. Having to shake off the unwanted residue can cause the blade cartridge to separate from the rest of the razor handle, requiring reassembly of the blade cartridge. With modern blades being fitted so close together, a regular water stream is not strong enough to remove all the unwanted buildup.

Therefore, it would be beneficial to have an alternative system and method for cleaning blades that is able to remove debris in order to prolong the actual and perceived life of the blades, disinfect the razor, and be both portable and fast performing.

### SUMMARY OF THE INVENTION

The needs set forth herein as well as further and other needs and advantages are addressed by the present embodiments, which illustrate solutions and advantages described below.

The system of the present embodiment includes, but is not limited to a blade cleaner system having a housing with at least one basin set within the housing. The housing having at least one opening sized to receive a shaving blade and at least one rotatably operated cleaning agent, having multiple bristles, adapted to clean the shaving blade, the cleaning agent being located proximate to the opening and a cleaning solution being present within the at least one basin. During operation, the cleaning solution can be in contact with a first portion of the at least one cleaning agent and a second portion of the cleaning agent may not contact the cleaning solution. The system can be placed in a bathroom and be secured to the sink or wall using a pair of suction cups or other restraints.

Another benefit of an embodiment of the present solution is that the cleaning agent can be moveably operated. The cleaning agent can be bristled, as a brush, with the bristles being made of a nylon material. The cleaning agent can be motorized to operate rotatably.

Yet another benefit of an embodiment of the present solution is that the cleaning agent can include an indicator as to the status of the cleaning agent, the indicator can include a fading color.

Yet another benefit of an embodiment of the present solution is having a method of using a blade cleaner system by placing a shaving mechanism in contact with a cleaning agent wherein the cleaning agent can be located within a basin of a housing, operating the cleaning agent and removing debris from the shaving mechanism using the cleaning agent and a cleaning solution located within the basin. The shaving mechanism can be a single blade, a safety razor, or a razor blade cartridge.

Other embodiments of the system and method are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIG. 1 shows one embodiment of the blade cleaner system, according to the present teachings.

FIG. 2 shows an exploded view of an embodiment of the blade cleaner system.

FIG. 3 shows a top view of an embodiment of the blade cleaner system.

FIG. 4 shows an exploded view of an embodiment of the blade cleaner system.

### DETAILED DESCRIPTION

The present teachings are described more fully hereinafter with reference to the accompanying drawings, in which the present embodiments are shown. The following description is presented for illustrative purposes only and the present teachings should not be limited to these embodiments.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

A blade cleaner system according to the present teachings, may accommodate a razor blade cartridge with any number of blades, including disposable multi-blade razors. This blade cleaner may be used with any razor, irrespective of the brand. The blade cleaner may be small enough to be portable. The blade cleaner may be waterproof to accommodate use of blades in a wet environment, such as next to the sink or in the shower.

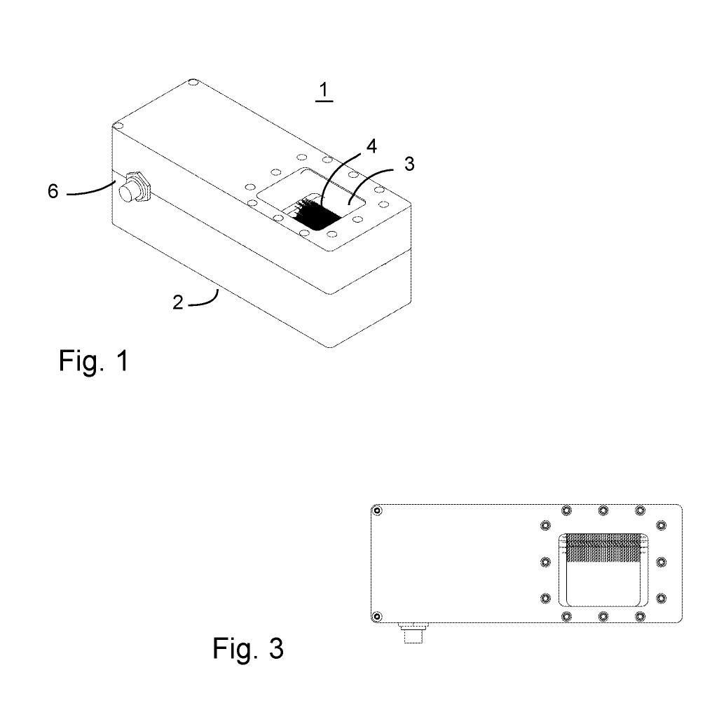

Referring now to FIG. 1 blade cleaner system 1 can include a housing 2, wherein the housing includes an opening leading to a basin 3. A cleaning agent 4 can be placed within the opening. The opening should be large enough to allow a blade or shaving cartridge to pass through. The basin can also include a cleaning solution (not shown). The blade cleaner system housing 2 may be made of plastic and may be waterproof. The opening may fit blade cartridges of any brand of razors with any number of blades. The system preferably being operated by rotating the cleaning agent 4 against a blade of set of blades of a shaving mechanism thereby brushing off shaving debris which may be caking on the blades. The cleaning agent 4 also preferably comes in contact with the cleaning solution thereby bringing the cleaning solution in contact with the blades, rinsing and helping clean the blades of the mechanism. The opening could also act as a splash guard to ensure that the cleaning solution does not spray out of the mechanism.

The cleaning agent 4 can be rotatably operated by a power source or manually. A battery can be used to power the cleaning agent 4. The cleaning agent can be bristled, as a brush, with the bristles being of a nylon material. Preferably the material can be 6.6 grade nylon. This material may be preferable due to its water absorbent properties when compared to other materials. The material may also be preferred because it is strong enough to not be damaged or cut by the blades yet be flexible enough to not damage the blades upon contact.

The bristles can have a diameter between about 0.002 and 0.004 inches, and preferably 0.003 inches, although not limited thereto. This size may be optimal because it allows the bristles to also clean the spaces between the blades of a cartridge, but at the same time the bristles are large enough to carry a necessary amount of solution to wash away the debris and build up.

The bristles can include a color pattern indicator which fades as the bristles or solution are used up. The housing can also include an indicator 5 showing the level of the solution. The indicator 5 can be in the form or a window to the basin. It is preferred that the solution cover approximately a bottom quarter to half of the cleaning agent 4, leaving a portion of the cleaning agent 4 to not contact the cleaning solution during operation. This level results in an optimum amount of solution being carried and coming in contact with the blades.

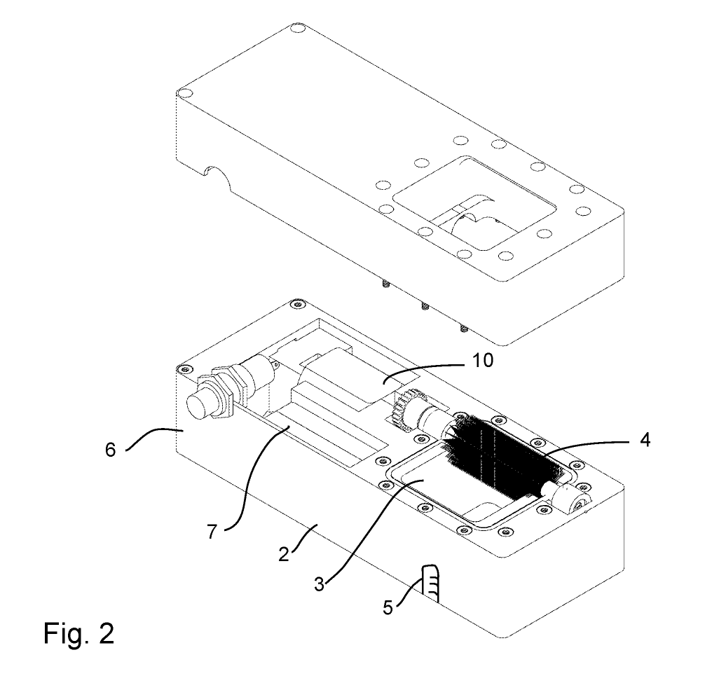

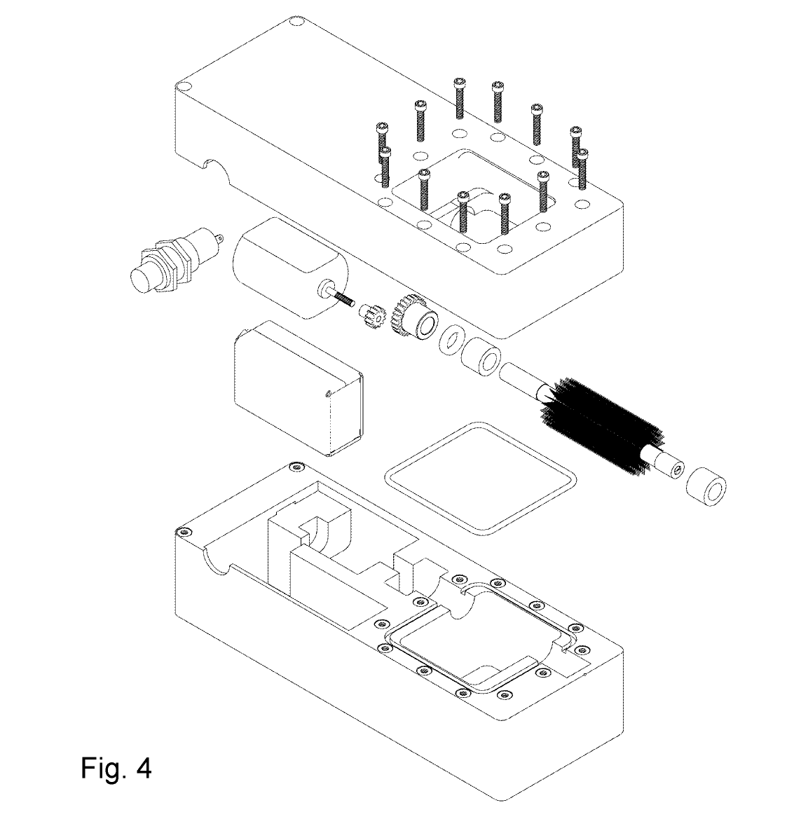

Referring now to FIG. 2, details of an embodiment of the blade cleaner system 1 are shown. The blade cleaner system 1 may be operated by motor 10 and turned on by a power button/switch 6 connected to a power source 7, which here is shown as a nine-volt battery.

As the cleaning agent 4 is spun against the blades of the cartridge, debris may be deposited in the basin 3. The basin 3 can be removed to get rid of the debris, and to be cleaned. The basin 3 may be cleaned by pressing down on basin 3, removing the basin 3, and rinsing the basin 3 after use. Alternatively, the basin 3 can be slidably removed from the housing 2.

In an alternative embodiment the cleaning solution may be an ultrasound solution. A second or alternative motor can be placed within the housing to produce ultrasound vibrations in the solution. This embodiment can include a brush or be used without a brush. The washing solution may be used to disinfect the blades to reduce the risk of infection and razor burn. The cleaning of the blades may allow air to circulate freely between the blades after use for a quick and easy air dry, thus preventing rust.

In one embodiment, the blade cleaner system 1 may be used by: securing the blade cleaner system 1 to a surface using suction cups, pressing the power button 6 to turn on the system and then placing a blade cartridge against the cleaning agent 4 and allowing the cleaning agent 4 to clean the blades and between the blades. Alternatively, a sensor can be used to activate the cleaning agent 4. A user may insert the blade cartridge into the blade cleaner system 1, and as the blades pass by the sensor, the cleaning agent 4 can be activated. Once done with the cleaning and the shaving mechanism can be removed, the sensor then causing the cleaning agent 4 to be deactivated. The blade cleaner system can be preprogrammed to turn off after a predetermined amount of time, for instance between 5 and 10 seconds. This can save the user the extra step of having to press the power button to turn off the mechanism. If the mechanism is sensor activated, this feature can act as a backup in case the sensor fails.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A blade cleaner system comprising:
a housing;
at least one basin set within the housing;
the housing having at least one opening sized to receive a shaving blade;
at least one rotatably operated cleaning agent, having multiple bristles, adapted to clean the shaving blade, being located proximate to the at least one opening;
a cleaning solution being present within the at least one basin; and
the cleaning solution being in contact with a first portion of the at least one cleaning agent during operation of the at least one cleaning agent.

2. The blade cleaner system of claim 1, wherein a second portion of the at least one cleaning agent is above the cleaning solution.

3. The blade cleaner system of claim 1, wherein the at least one cleaning agent is motorized.

4. The blade cleaner system of claim 1, wherein the at least one cleaning agent is contained within the housing.

5. A blade cleaner system comprising:
a housing;
the housing including at least one basin adapted to receive a blade;
at least one cleaning agent adapted to clean a blade being located proximate an opening of the basin; and
a cleaning solution being present within the at least one basin.

6. The system of claim 5, wherein the at least one cleaning agent is moveably operated.

7. The system of claim 5, wherein the at least one cleaning agent includes multiple bristles.

8. The system of claim 7, wherein the bristles are of a nylon material.

9. The system of claim 7, wherein the bristles are between about 0.002 inches and 0.004 inches in diameter.

10. The system of claim 7, wherein the bristles are of an absorbent filament.

11. The system of claim 5, wherein the housing includes a cleaning solution level indicator.

12. The system of claim 5, wherein the at least one cleaning agent is battery powered.

13. The system of claim 5, wherein the at least one cleaning agent is rotatably operated.

14. The system of claim 5, wherein the at least one cleaning agent includes a cleaning agent status indicator.

15. The system of claim 5, further comprising at least one suction cup connectable with the housing.

16. A method of using a blade cleaner system comprising the steps of:
filling a basin with a cleaning solution to a predetermined level relative to a cleaning agent;
placing a shaving mechanism proximate to the cleaning agent wherein the cleaning agent is located within an opening adapted to receive the shaving mechanism; and
removing debris from the shaving mechanism using the cleaning agent and the cleaning solution by operating the cleaning agent.

17. The method of claim 16, wherein the cleaning agent includes at least one moveably operated brush.

18. The method of claim 16, wherein the shaving mechanism includes at least a pair of blades.

19. The method of claim 16, wherein the cleaning agent deposits the cleaning solution on the blades.

20. The method of claim 16, wherein the cleaning agent is operated for a preprogrammed amount of time.
